(19) United States
(12) Patent Application Publication
(10) Pub. No.: US 2004/0022080 A1
(43) Pub. Date: Feb. 5, 2004

(54) Switching transformer

(76) Inventors: Harald Weinmeier, Vienna (AT); Andreas Kranister, Wilhelmsburg (AT)

Correspondence Address: CHRISTIE, PARKER & HALE, LLP, 350 WEST COLORADO BOULEVARD, SUITE 500, PASADENA, CA, 91105, US

(21) Appl. No.: 10/311,647

(22) PCT Filed: Jun. 12, 2001
(86) PCT No.: PCT/AT01/00194

(30) Foreign Application Priority Data
Jun. 16, 2000 (AT) A1052000

(51) Int. Cl. H02M 7/5387

(52) U.S. Cl. 363/132

(57) ABSTRACT

A switching converter comprising a transformer for converting an input direct current (U_{E}) into an output direct current (U_{A}) in which at least two primary windings (L1 . . . L4; W1, W2) of a transformer (Tr) are provided; and each primary winding is connected to an input capacitor (C1 . . . C4; C11+C12; C21+C22) by means of at least one controlled switch (T1 . . . T4; T11 . . . T22) whereby the input capacitors together with the series connections of the primary windings with the controlled switches that are connected in series are connected to the input direct current (U₁) and a control circuit (AST) is configured to simultaneously open or close all the controlled switches.

The invention relates to a switching converter to convert an input direct current into an output direct current with a transformer that has at least one primary winding that may be connected in series with a controlled switch to a direct current, with at least one secondary winding to which a rectifier is connected downstream, and with a control circuit for the at least one controlled switch.

Switching converters of this type have become known in a large number of embodiments, either as blocking converters or as a flow converter. They are used for the power supply of electrical and electronic devices. Reference can be made, for example, to Hirschmann Hauenstein, “Schaltnetzteile [Switching Network Components]”. Verlag Siemens 1990: Thiel “Schaltnetzteileapplikationen [Switching Network Component Applications]” Franzis Verlag 1996, or Klingenstein, “Schaltnetzteile in der Praxis [Switching Network Components in Practice]”, Vogel-Fachbuch 1988. The control circuits are usually implemented in bulk in IC modules that are produced in high quantities and are commercially available.

The input direct current is frequently a so-called intermediate loop voltage obtained by rectifying line voltage. In this case, the intermediate loop voltage could even be very high, for example above 500 volts or even 1600 volts, if no stepdown transformer is used on the input side. However, with such high voltages, problems occur with regard to the voltage strength of the input (electrolytic) capacitors on the one hand and the controlled switches that are usually switching transistors.

There are various ways to solve this problem. For example, it is possible to connect a plurality of input capacitors in series, but it is essential, for instance, to introduce balancing, i.e. uniform voltage distribution to the capacitors, using energy Consuming resistors. Also possible are bridge circuits, as described, for instance, in U. Tietze, Ch. Schenk, “Halbleiterschaltungstechnik [Semiconductor Circuit Technology]”, Springer-Verlag, 8th edition. Section 18.7.2. Select highly blocking switching transistors are very expensive and the problem of balancing also occurs with the series connection of switching transistors.

DE 34 41 631 A1 describes approaches for a solution that use a plurality of transformers with controlled switches on the primary side, for example, six individual transformers that are connected in series on the input side. The rectified outputs are connected in parallel. The input direct current is distributed to a plurality of input capacitors, e.g., to six capacitors. Combined converters of this type are, to be sure, usable for high input direct currents; however, the expenditure due to the use of individual transformers for each converter subunit is high from every standpoint. Since the tolerances in the transformer structure are very large, balancing, i.e., a virtually identical distribution of the partial input voltages to the individual controlled switches is costly. If blocking converters are used, a demagnetizing winding must be provided for each transformer.

From U.S. Pat. No. 5,365,421 A, a control circuit for traveling wave tubes has become known to supply these traveling wave tubes pulses of high voltage and high power. Pulses of approximately 40 kV must be applied to the traveling wave tubes, for which hydrogen thyratrons or high vacuum switches can be used; however, either a short service life occurs with hydrogen thyratrons or the production of x-rays occurs with high vacuum switches when these are connected to a capacitor bank. To remedy these disadvantages. U.S. Pat. No. 5,365,421 A uses a transformer with cascade connectable individual windings that are connected upon arrival of a trigger pulse on pulse capacitors. Each capacitor is almost completely discharged via its primary winding, whereby on the secondary side the pulse generated is clamped at ca. 40 kV. This pulse connection has, however, nothing to do with conventional switching network components as they are the object of the present invention.

One object of the invention is to provide a switching converter comprising a transformer that can also be used for high input direct currents, but without resulting in special costs or a high switching consumption, and to do so regardless of the converter principle used.

This object is accomplished with a switching converter comprising a transformer of the type mentioned in the introduction, in which at least two primary windings are provided, and each primary winding is connected via at least one controlled switch to an input capacitor, whereby the input capacitors together with the series connections of the primary windings are connected with the controlled switch in series to the input direct current and the control circuit is configured to simultaneously open or close all the controlled switches.

Thanks to the invention, switching converters are provided that can operate at high input or intermediate loop voltages, whereby the costs still remain in acceptable ranges since only a single transformer is required.

An expedient variant is distinguished by the fact that each primary winding is connected to each winding end in series with one controlled switch each; these serial connections are in turn connected in series to the input direct current and are jumpered from a respective input capacitor.

This variant does, to be sure, require more controlled switches, but their voltage strength may be even lower. In addition, the symmetry of the circuit has a positive effect on the balancing or distribution of the input direct current.

In the last mentioned variant, it is particularly expedient if each primary winding has a core tap and each input capacitor consists of two partial capacitors connected in series, whereby the core tap of each winding is connected with the connecting point of the associated partial capacitor. This enables the input voltage associated with each primary winding to be distributed again such that capacitors with low voltage strength may be used.

In an embodiment of the switching converter as a flow converter, it is expedient for the transformer to have a demagnetizing winding connected to the input direct current via a blocking diode.

On the other hand, it is possible to get by without a demagnetizing winding if two backflow diodes are associated with each primary winding, whereby one diode each jumpers the series connection of the respective primary winding with one of its controlled switches.

To avoid saturation states of the transformer, it is recommended for the control circuit to be configured to control the controlled switch while maintaining a pulse duty factor of less than 0.5.

With regard to an optimum distribution of the input direct current, it is advisable for all input capacitors on one side and primary windings on the other side to be dimensioned identically.

In terms of specifically suitable control of the switch, an embodiment is advisable in which the control circuit has a pulse-width modulator that connects the primary winding of a control transformer via a drive switch to an auxiliary direct current, whereby the transformer has a number of secondary windings corresponding to the selection of the controlled switches, the output voltages of which secondary windings are used to control the controlled switches.

The invention along with additional advantages is explained in detail in the following with reference to exemplary embodiments illustrated in the drawings. They depict:

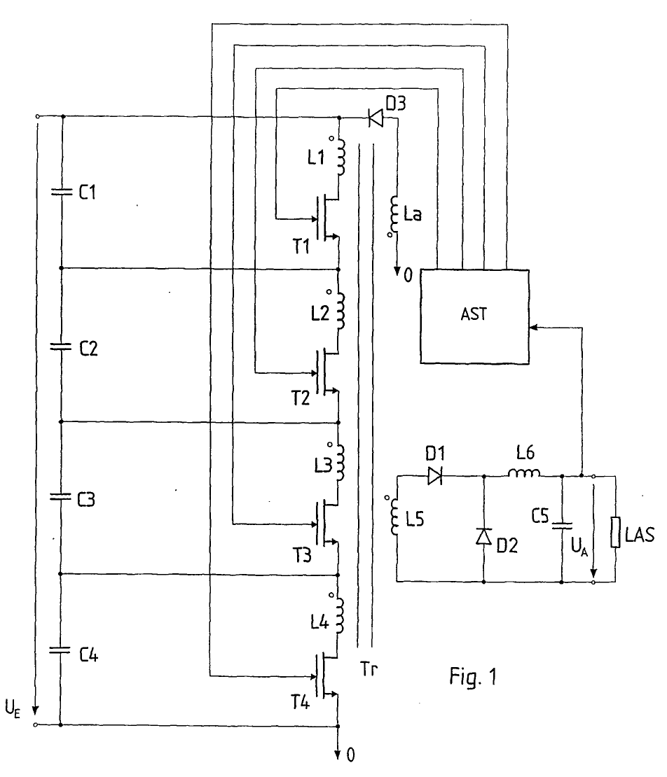

FIG. 1 in a simplified schematic circuit diagram, a first embodiment of a switching converter according to the invention designed as a flow converter,

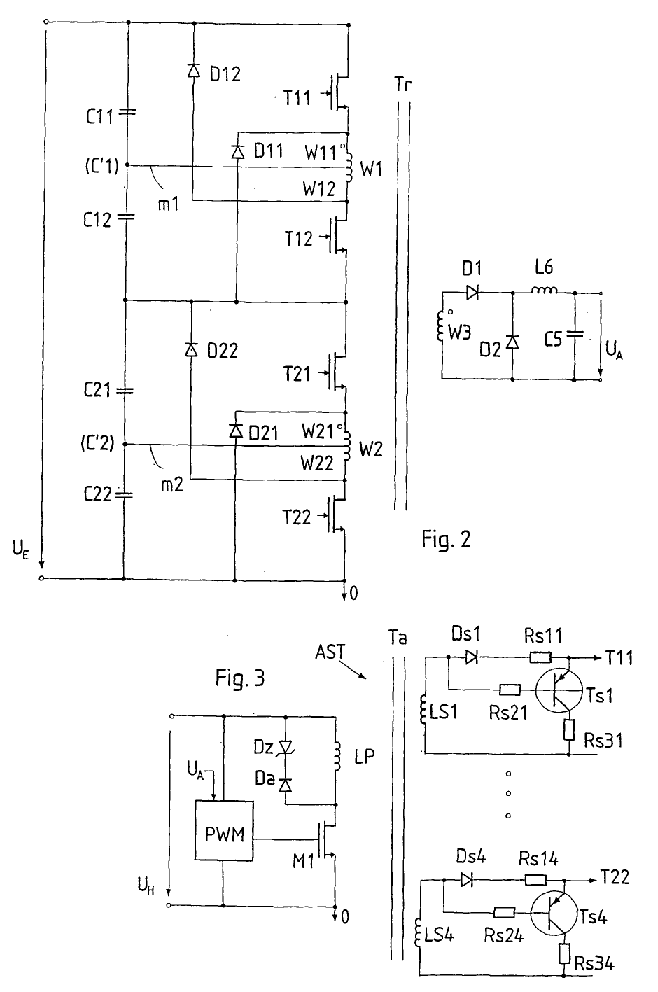

FIG. 2 in a schematic circuit diagram and omitting the control circuit, a second embodiment of the invention, also designed as a flow converter, and

FIG. 3 a control circuit that is particularly suited for switching converters according to the invention, in a schematic circuit diagram.

According to FIG. 1, a switching converter according to the invention has a transformer Tr with four primary windings L1, L2, L3, L4, one secondary winding L5, and one demagnetizing coil L. Each primary winding L1 . . . L4 is connected in series with a controlled switch T1 . . . T4 to an input capacitor C1 . . . C4, whereby all these capacitors can be connected in series to an input direct current U_{F}. The individual series connections L1-T1 . . . L4-T4 of the primary windings with the switches associated therewith are also connected in series to the input direct current U_{E}.

A rectifier D1 with a secondary inductor L6 and an output capacitor C5 is connected downstream from the secondary winding L5. The output direct current U_{A} of the converter is connected to the output capacitor. A freewheeling diode D2 leads from ground to the connection point of the rectifier diode D1 with the secondary inductor L6.

To control the controlled switches T1 . . . T4, implemented, for instance as field effect transistors, a control circuit AST that differs from conventional control circuits only in that in the invention two or more, in this case four, switches T1 . . . T4 are controlled such that they open or close simultaneously. For regulation, e.g., to constant output voltage, a corresponding actual signal can be fed to the control circuit, as here in FIG. 1, for instance, the output voltage U_{A}. A possible control circuit is explained below in somewhat greater detail.

The previously mentioned demagnetizing coil is connected on one end to (primary) ground and on the other end via a diode D3 to the input direct current U_{E}. This serves in known fashion in flow converters to demagnetize the transformer core.

It should be clear to the person skilled in the art that the invention can also be implemented as a blocking converter. In this case, the secondary inductor L6 could be omitted in FIG. 1, as well as the demagnetizing winding Lₐ, and the secondary winding L5 would have its poles reversed. Thus, the energy stored in the core is no longer discharged back into the input capacitors C1 . . . C4 but into the output capacitor C5 or a load LAS.

Since the controlled switches T1 . . . T4 open and close simultaneously, whereby in each case current from the series coupled input capacitors C1 . . . C4 flows into the primary windings L1 . . . L4, the capacitors are automatically balanced, i.e., the input voltage U_{E} is distributed to the capacitors in equal parts, one fourth each in this case. By means of this cascading, it is possible to use switching transistors of low voltage strength, even with high input direct current U_{F}. The same is true for the input capacitors C1 . . . C4, which then must, for example, be dimensioned for only 300 volts each, even with an input voltage of 1200 volts, for instance, such that electrolytic capacitors can be used with no problem.

The embodiment according to FIG. 2 is also designed as a flow converter and has two primary windings W1, W2 with core taps m1, m2, whereby a capacitor C11, C12, C21, C22 is associated with each half winding W11, W12, W21, W22. These capacitors, also referred to here as partial capacitors, are coupled in series to the input direct current U_{E}. The circuit according to FIG. 2 is also conceivable without a core tap, whereby then, instead of the partial capacitors C11, C12, a capacitor C1′ would be provided; and, instead of the partial capacitors C21, C22, a capacitor C2′, as indicated in parentheses in FIG. 2.

One controlled switch T11, T12 or T21, T22 each is connected to each end of the primary windings W1 or W2, respectively; and the series connections T11-W1-T12, T21-W2-T22 are in turn coupled in series to the input direct current U_{E}.

To demagnetize the transformer core, in the variant according to FIG. 2, demagnetizing diodes D11 . . . D22 are provided, whereby one diode each, e.g., D11 or D12, jumpers the series connection of the respective primary winding, e.g., with one of its controlled switches, e.g., T11 or T12. It is possible to omit an individual demagnetizing winding by using backflow diodes, and it is guaranteed that the controlled switches are not put at risk from high cutoff voltages caused by the leakage inductance of the transformer.

On the secondary side, the embodiment according to FIG. 2 corresponds to that of FIG. 1; however, all designs known to the person skilled in the art could be used here, in particular even a plurality of secondary windings to obtain electrically isolated, distinct output voltages.

Also in the embodiment according to FIG. 2, a control circuit, such as that described below in conjunction with FIG. 3, configured to simultaneously open or close all four controlled switches T11 . . . T22, e.g., field effect transistors. With the blocking of the transistors, current flow through the diodes D11, D12 or D21, D22 into the capacitors C11, C12 or C21, C22 is guaranteed such that—as mentioned above—a demagnetizing winding is not necessary. The primary inductances are demagnetized to the same strength to which they were magnetized. For this reason, the pulse duty factor of the control pulse is expediently selected less than 0.5.

Although it is known to the person skilled in the art, it should be mentioned that the voltage strength of the switching transistors does not have to be set exclusively according to the level of the input voltage—divided here—, but rather—because of the cutoff voltages—also according to the pulse duty factor and the ratio of the primary to the secondary inductances. In the example depicted in FIG. 2, the voltage strength of the switching transistors should be 800 volts—based on an input direct current U_{E}=1600 volts, whereas the operating voltage of the capacitors only has to be 400 volts. The blocking voltage of the backflow or demagnetizing diodes D11 . . . D22 must not be higher than 800 to 1000 volts.

FIG. 3 depicts a control circuit AST that can be used for the control of the four switches T11 T22 of FIG. 2. The core of the control circuit is a known pulse width modulator PWM, commercially available in many variants, that is supplied with auxiliary voltage U_{H}. This voltage may be obtained, for example, by means of an additional winding of the transformer and a rectifier along with smoothing means. To regulate the output voltage U_{A}, a voltage proportional thereto and/or an actual current value is fed to the pulse width modulator.

The pulse width modulator PWM controls a driver transistor M1, coupled in series with a primary winding Lₚ of a control transformer Tr to the auxiliary voltage U_{H}. The series connection of a Zener diode DZ with a diode Dₐ whereby upon cutoff, demagnetizing can occur via the Zener diode.

The control transformer Tₐ, which is used for the electrical isolation of the switching transistors T11-T22 from the pulse width modulator PWM, has the required number of secondary windings Ls1 . . . Ls4, four, in this case. The switching signal is guided via a diode Ds1 and a resistor Rs11 to the gate of the first switching transistor T11 and via a base resistor Rs21 to the base of a transistor Ts1. With a positive control signal, the input capacitance of the controlled field effect transistor T11 is charged via the diode Ds1 and the resistor Rs11. Since the demagnetizing proceeds more slowly than the magnetizing, at the time of the turning off of the driver transistor M1, the transistor Ts1 becomes conductive, and the charge of the input capacitance of the field effect transistor T11 can be discharged via the collector resistor Rs31 of the transistor Ts1. The connection of the other secondary windings of the control transformer Tₐ, of which only the first and the fourth are depicted, are [sic] identically implemented, and their function is identical and simultaneous.

1. Switching converter comprising a transformer for the conversion of an input direct current (U_{L}) into an output direct current (U_{A}), with a transformer (Tr) that has at least one primary winding (L1 . . . L4; W1, W2), that can be connected in series with a controlled switch (T1 . . . T4, T11 . . . T22) to a direct current, with at least one secondary winding (L5; W3), to which a rectifier (D1) is connected downstream, and with a control circuit (AST) for the at least one controlled switch,
characterized in that
at least two primary windings (L1 . . . L4, W1, W2) are provided, and each primary winding is connected via at least one controlled switch (T1 . . . T4, T11 . . . T22) to an input capacitor (C1 . . . C4; C11+C12; C21+C22), whereby the input capacitors together with the series connections of the primary windings are coupled with the controlled switches connected in series to the input direct current (U_{E}) and the control circuit (AST) is configured to periodically simultaneously open or close all the controlled switches.

2. Switching converter comprising a transformer according to claim 1, characterized in that each primary winding is connected to each winding end in series with one controlled switch each (T11, T12; T21, T22), these series connections (T11-W1-T12; T21-W2-T22) are in turn connected in series to the input direct current (U_{E}) and are jumpered by a respective input capacitor (C1′, C2′).

3. Switching converter comprising a transformer according to claim 2, characterized in that each primary winding (W1, W2) has a core tap (m1, m2) and each input capacitor (C1′, C2′) consists of two partial capacitors (C11, C12; C21, C22) connected in series, whereby the core tap of each winding is connected with the connecting point of the associated partial capacitor.

4. Switching converter comprising a transformer according to one of claims 1 through 3, characterized in that the transformer (Tr) has a demagnetizing winding (Lₐ) coupled by a blocking diode (D3) to the input direct current (U_{E}).

5. Switching converter comprising a transformer according to claim 2, characterized in that two demagnetizing diodes (D1 . . . D22) are associated with each primary winding (W11 . . . W22), whereby a respective diode (D11 or D12) jumpers the series connection of the respective primary winding (W1) with one of its controlled switches (T11 or T12).

6. Switching converter comprising a transformer according to one of claims 1 through 5, characterized in that the control circuit (AST) is configured to control the controlled switches (T1 . . . T4; T11 . . . T22) while maintaining a pulse duty factor that is less than 0.5.

7. Switching converter comprising a transformer according to one of claims 1 through 6, characterized in that all input capacitors (C1 . . . C4; C11 . . . C22) on the one hand and primary windings (L1 . . . L4; W1, W2) on the other are identically dimensioned.

8. Switching converter comprising a transformer according to one of claims 1 through 7, characterized in that the control circuit (AST) has a pulse-width modulator (PWM), which connects the primary winding (Lₚ) of a control transformer (Tₐ) by means of a drive switch (M1) to an auxiliary direct current (U_{H}), whereby the transformer (Tₐ) has a number of secondary windings (L_{S1} . . . L_{S4}) corresponding to the selection of controlled switches (T1 . . . T4; T11 . . . T22), of which secondary windings the output voltage is used to control the controlled switches.
